(19) United States
(12) Patent Application Publication
(10) Pub. No.: US 2009/0151961 A1
(43) Pub. Date: Jun. 18, 2009

(54) Residential Exterior Deluge System

(76) Inventor: Ronald J. Voorhees, Houston, TX (US)

Correspondence Address: TIM COOK, P.O. BOX 10107, LIBERTY, TX, 77575, US

(21) Appl. No.: 11/956,872

(22) Filed: Dec. 14, 2007

(51) Int. Cl. A62C 35/00

(52) U.S. Cl. 169/13

(57) ABSTRACT

An automatically available curtain of water to the outside of a residence is provided by a residential fire-protection system. A supply line is provided from a swimming pool or other stored quantity of water to a pump. The pump provides water under pressure to a spray line, which may preferably be located on the ridges of the residence or may preferably be positioned at the level of the foundation of the residence. The spray line creates a wall or curtain of water between the structure and an approaching fire to prevent the residence from catching on fire. A plurality of heat sensors detect the approach of an exterior fire, and automatically initiate the fire protection system.

### FIELD OF THE INVENTION

The present invention relates generally to the field of residential fire protection systems and, more particularly, to a residential deluge system that preferably uses an existing swimming pool as a primary source of water for an exterior spray system for a residence.

### BACKGROUND OF THE INVENTION

Automatic fire sprinkler systems in the interior of homes provide obvious benefits for both homeowners and fire-fighting first responders. Automatic fire sprinklers are generally installed in homes in accordance with codes of local fire authorities and in accordance with codes promulgated by National Fire Protection Association (NFPA) requirements. These codes require a sustained water supply at a given water pressure for a given period of time, called the system “demand”. The system demand for a single family residence is, generally, a minimum 60 pounds of water pressure to force water through the sprinkler heads for a period of 10 minutes. A residential fire sprinkler water supply system was taught by Phillips in U.S. Pat. No. 6,009,954.

While these types of systems have been shown to provide protection from fires within a home, they provide no protection against the catastrophic damage from wildfires, such as those which have recently ravaged southern California and other areas of the United States. In the recent California fires, unless he was ordered to leave the area, the usual way for a resident to try to protect his home was to turn on a garden hose to spray water onto the roof of his house. This technique was ineffective and almost all of the time the homeowner was ordered to abandon the effort in order to save his own life as the wildfire approached his home.

In some industrial areas having particular hazards such as highly flammable fluids and gases, a deluge system may be installed to initiate under certain conditions. Deluge systems are systems that have open sprinklers, i.e. the heat sensing operating element is removed during installation, so that all sprinklers connected to the water piping system are open. These systems are used for special hazards where rapid fire spread is a concern, as they provide a simultaneous application of water over the entire hazard.

In a typical industrial deluge system, water is not present in the piping until the system operates. Because the sprinkler orifices are open, the piping is at ambient air pressure. To prevent the water supply pressure from forcing water into the piping, a deluge valve is used in the water supply connection, which is a mechanically latched, non-resetting valve, so that it stays open once tripped. However, water system pressure is constantly maintained on the upstream side of the deluge valve so that water is immediately available once the deluge valve is opened.

Because the heat sensing elements present in the automatic sprinklers have been removed, the deluge valve must be opened as signaled by a specialized system. The type of initiating device selected depends mainly on the hazard (e.g., smoke detectors, heat detectors, or optical flame detection). The initiation device signals a fire alarm panel, which in turn signals the deluge valve to open.

Unfortunately, these types of systems have not been adapted for installation at a residence. Also, these types of deluge systems are either coupled to a supply main dedicated to this purpose or have specially installed supply tanks for this and no other purpose. Thus, there remains a need for a system to protect the exterior of a residence that is inexpensive, relative to the cost of replacing the structure. The system should take advantage of existing systems already in place, such as an installed swimming pool, or utilize these types of systems for dual purposes. The present invention is directed to filling this need in the art.

### SUMMARY OF THE INVENTION

The fire protection system described herein provides an automatically available curtain of water to the outside of a residence, but is relatively unobtrusive when not in use so as not to spoil the esthetics of the structure. A supply line is provided from a swimming pool or other stored quantity of water to a pump. The pump provides water under pressure to a spray line, which may preferably be located on the ridges of the residence or may preferably be positioned at the level of the foundation of the residence. The spray line creates a wall or curtain of water between the structure and an approaching fire to prevent the residence from catching on fire. A plurality of heat sensors detect the approach of an exterior fire, and automatically initiate the fire protection system.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a perspective view of a preferred embodiment of a fire protection system installed on a residence, with a spray line mounted on a roof ridge.

FIG. 2 is a perspective view of a preferred embodiment of a fire protection system installed on a residence, with a spray line mounted at a foundation level.

FIG. 3 is a detail view of a spray apparatus applied to the embodiment of FIG. 2.

FIG. 4 is a detail view of a spray valve of the apparatus of FIG. 3 shown in a closed position.

FIG. 5 is a detail view of a spray valve of the apparatus of FIG. 3 shown in an open position.

FIG. 6 is a schematic view of a pump and spray apparatus for use in the present application.

### DETAILED DESCRIPTION OF A PREFERRED EMBODIMENT

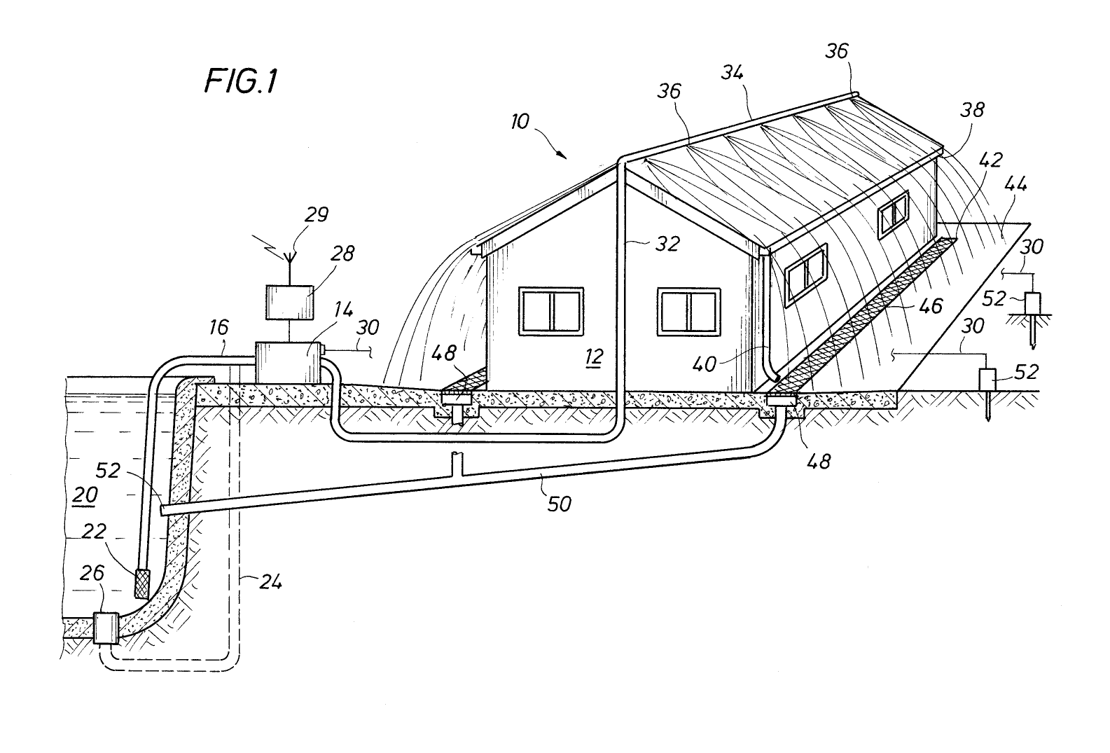

Referring first to FIG. 1, a sprinkler or deluge system 10 is adapted for installation on the exterior of a residence or dwelling 12. The system 10 includes a pump 14 with a suction line 16 and a discharge line 18. The suction line 16 preferably terminates within a swimming pool 20 installed at the dwelling 12 in the conventional manner. The suction line 16 terminates at a suction screen 22 to keep the suction line clear of debris. Alternatively, if the sprinkler system 10 is installed simultaneously or with preplanning with the swimming pool 20, a suction line 24 may be coupled to a drain line 26 so that the maximum quantity of water is available from the pool.

The pump 14 may be an electrical pump started by a signal over a signal input line 30. Alternatively, the pump may be a gasoline powered pump, or a diesel powered pump. If the pump requires fuel, care must be taken to isolate the fuel from a wildfire from which the system is designed to protect. The pump is operated from a control panel 28, which receives signals as described below and automatically starts the pump. The control panel 28 may also be provided with an antenna 29 to receive a remotely send signal to start and stop the system, if desired. The signal may be a radio frequency signal, a telephone operable signal, or similar electronic signal.

The pump takes a suction on the suction line 16 and pressurizes the discharge line 18 to a riser 32. The riser leads to a ridge line 34 which includes a plurality of spray nozzles 36.

In the embodiment of FIG. 1, once the ridge line 34 is pressurized, all of the spray nozzles 36 begin to spray water over the dwelling 12. Preferably, the spray extends over a gutter 38, so that a curtain of spray is created between the dwelling 12 and a fire adjacent the dwelling. Any water that does not extend over the gutter is captured in the gutter and directed into a drainline 40. The drainline 40 pours into a trench 42. The trench preferably extends around the entire periphery of the dwelling 12 so that water from the spray nozzles 36 is captured in the trench, whether the water flows into the gutter 38 or extends over the gutter 38. The water which extends over the gutter falls on a walkway 44, where is flows down into the trench 42. Preferably, the trench 42 is covered with a grating 46 for the safety and comfort of the residents of the dwelling.

The water from the trench flows into a drain 48 and into a drainline 50 so that the water flows back into the pool at an discharge 52. Alternatively, the captured water may be directed into the chlorine treatment system of the pool (not shown), if desired.

It should be noted at this point that the fire protection system may be installed without the capture portion, including the drain elements 42, 44, 46, 48, and 50. For a typical size pool measuring 20×30×8 feet, or 4800 cubic feet, i.e. 36,000 gallons of water, the system can spray 600 gallons per minute and still last an hour without replenishment. However, with the capture system just described, and/or supplementation from a water supply, this period of spray protection can be extended. Recent experience has shown that rapidly moving wildfires move through an area in less than 30 minutes.

The pump control panel 28 may start the pump from a variety of input signals. Preferably, the system includes one or more sensors 52 placed strategically around the entire periphery of the dwelling 12. Preferably, the sensors 52 are heat sensors, set at a threshold temperature that is high enough to prevent spurious operation of the system, yet low enough the start the system before any damages occurs. The sensor 52 sends a start signal over the signal line 30 to start the pump 14. In the embodiment of FIG. 1, a start signal from one sensor placed around the dwelling with initiate the start of the system so that spray is sent around the entire dwelling.

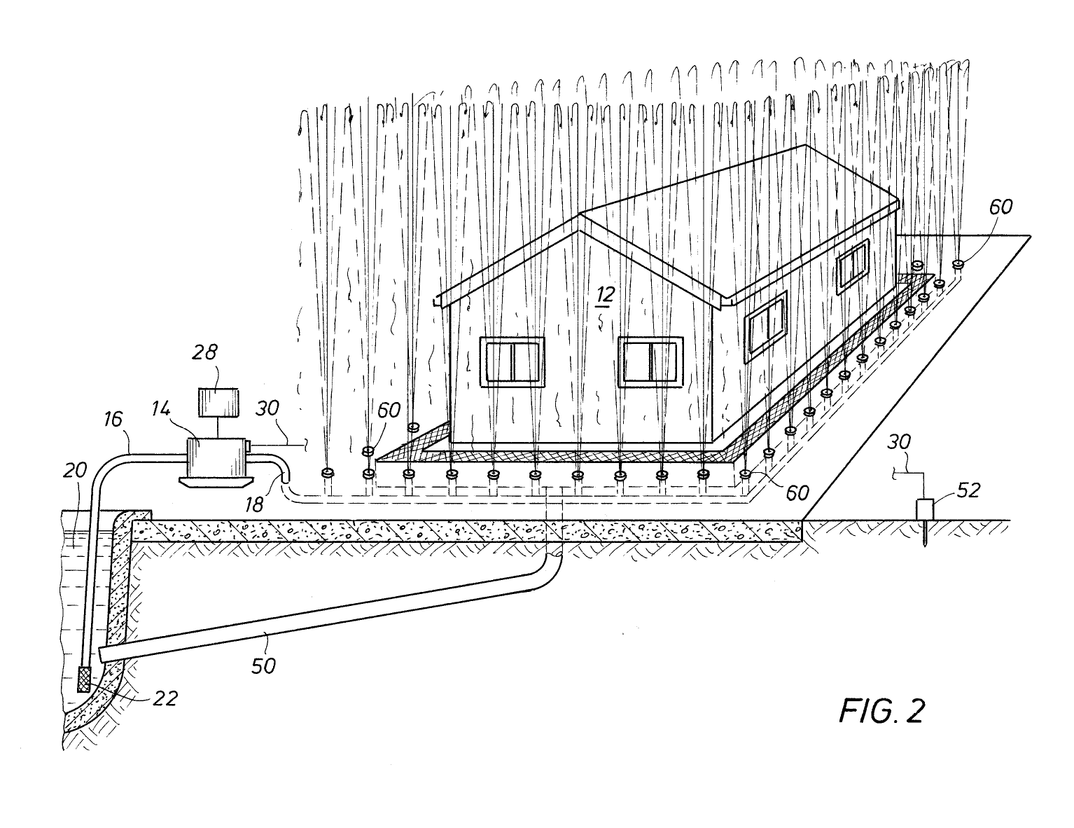

FIG. 2 depicts another preferred embodiment in which spray nozzles are arrayed around the dwelling 12 at foundation or ground level, which spray sent upward. The system includes the same source of water from the pool 20 through a suction strainer 22 into the suction line 16 into the pump 14. The system also includes the same control panel 28 adapted to receive control signals over the signal line 30. In this embodiment, however, a plurality of spray nozzles 60 arrayed around the dwelling 12 directed upward. The spray nozzles 60 are shown in FIG. 2 as spraying straight up, although they may be angled toward the dwelling 12, if desired. In either case, the spray nozzles form a substantially continuous curtain of water spray around the dwelling in the event of a fire outside the dwelling. The spray nozzles may be mounted above or below ground level around the dwelling.

Just as in the embodiment shown in FIG. 1, the system of FIG. 2 preferably includes a drain capture system to capture as much of the spray water as possible, including the drain line 50 back to the pool 20. The system also operates on one or more sensors 52 to send a control signals over a signal line 30.

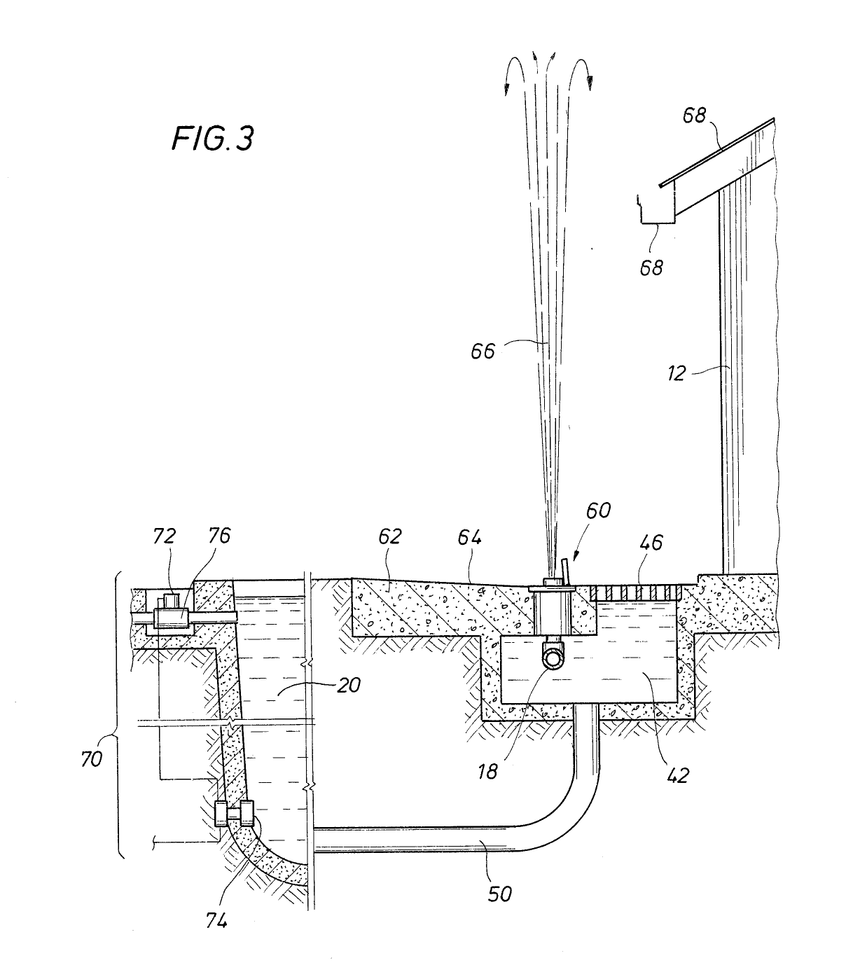

The system shown in FIG. 2 has the drawback of having spray nozzles at ground level, so that they may be walked on by residents or others. Thus, it would be preferable to have the spray nozzles present a flush profile during non-operational periods. This feature is illustrated in FIGS. 3 through 5.

FIGS. 3, 4, and 5 depict a presently preferred arrangement for the spray nozzles 60 placed at foot or foundation level. The spray nozzle 60 is preferably mounted in a concrete footing 62 which defines a sloped upper surface 64 so that water falling onto the surface 64 drains into the trench 42. The trench 42 is preferably covered by the grating 46 to eliminate a tripping hazard. The trench 42 includes one or more drain lines 50 which drains into the pool 20, or it may drain into a treatment system prior to draining into the pool, if desired.

The nozzles 60 are fed with water from the pump's discharge line 18. In the embodiment illustrated in FIG. 2 and FIG. 3, the spray nozzle 60 is directed vertically. In this way, a curtain of spray 66 created by the plurality of spray nozzle protects the structure or dwelling 12. Alternatively, the spray may be angled toward the dwelling 12, in which case a gutter 68 may capture some or substantially all of the spray directed onto a roof 68 of the dwelling. The gutter then directs the captured water into the drainline 40 (FIG. 1).

FIG. 3 depicts yet another feature of the fire protection system. As previously described, the primary source of water for the system is a pool 20, although an installed water tank or plurality of tanks may be used, if desired. However, to increase the length of time that spray can be maintained, an augmentation system 70 may be included. The augmentation system 70 may include a high level sensor 72 and a low level sensor 74. The high level sensor 72 opens a supply valve 76 to provide water to the pool when the water level drops below the level of the high level sensor. The low level sensor 74 shuts off the pump 14 when the water level in the pool drops below the low level sensor, or approximately the level of the inlet into the pump suction line 16, i.e. about the level of the suction screen 22 (FIG. 1). Thus, as the pump is started automatically and begins to draw down the level in the pool, the augmentation system adds more water to the pool to maintain net positive suction head at the inlet to the pump as long as possible.

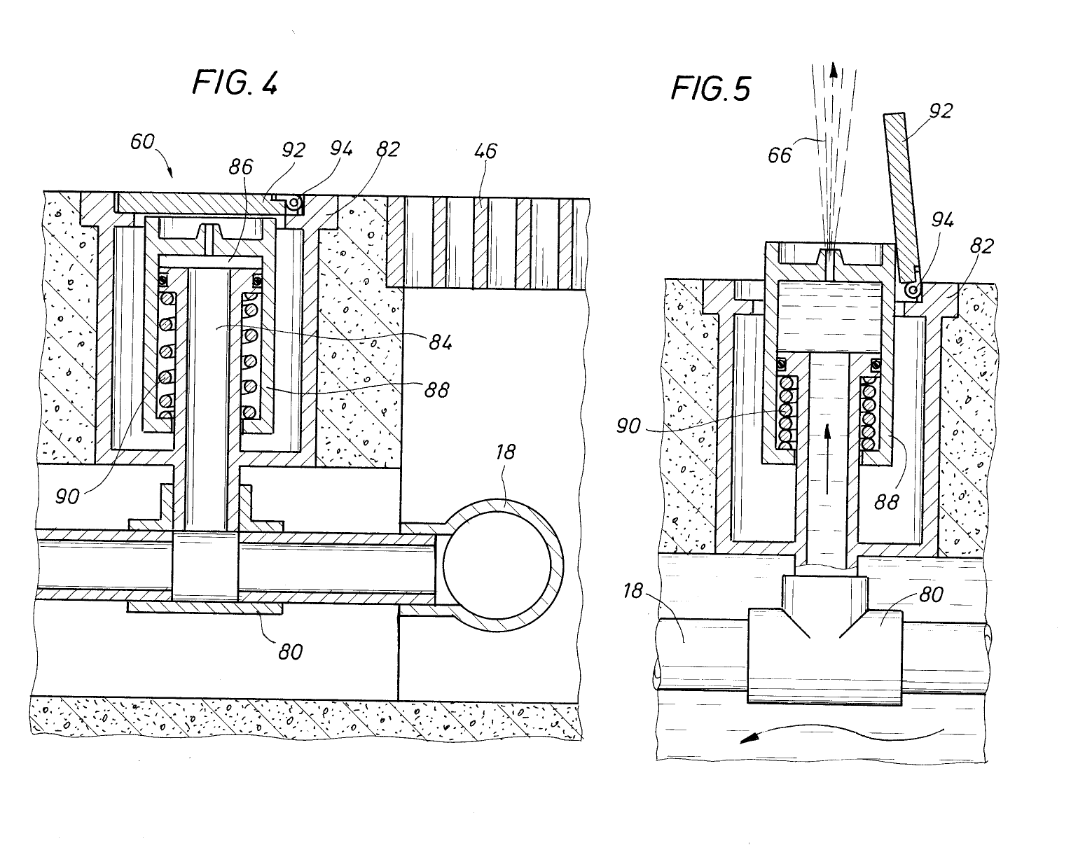

FIG. 4 and FIG. 5 provide details of the preferred spray nozzle 60 adapted for use in the embodiment of FIG. 2, i.e. with the spray nozzle positioned at foundation level. As previously described, the pump's discharge line 18 provide water under pressure to a plurality of spray nozzles 60. The spray nozzles are preferably coupled into the line 18 at a T-junction 80. The T-junction also couples to a spray nozzle body 82 which provides an internal riser 84. Water flows from the line 18, through the T-junction 80, up the riser 84, into an expandable cylinder section 86. Under pressure, the cylinder section expands, lifting a nozzle section 88 against biasing pressure of a spring 90. As the nozzle section 88 lifts, it abuts against a cover 92, thereby lifting the cover and exposing the nozzle section 88, which begins to spray water, as in the curtain of water spray 66 (FIG. 5). The cover rotates about an axis 94 which includes a biasing means to shut the cover when the pressure from the line 18 is stopped.

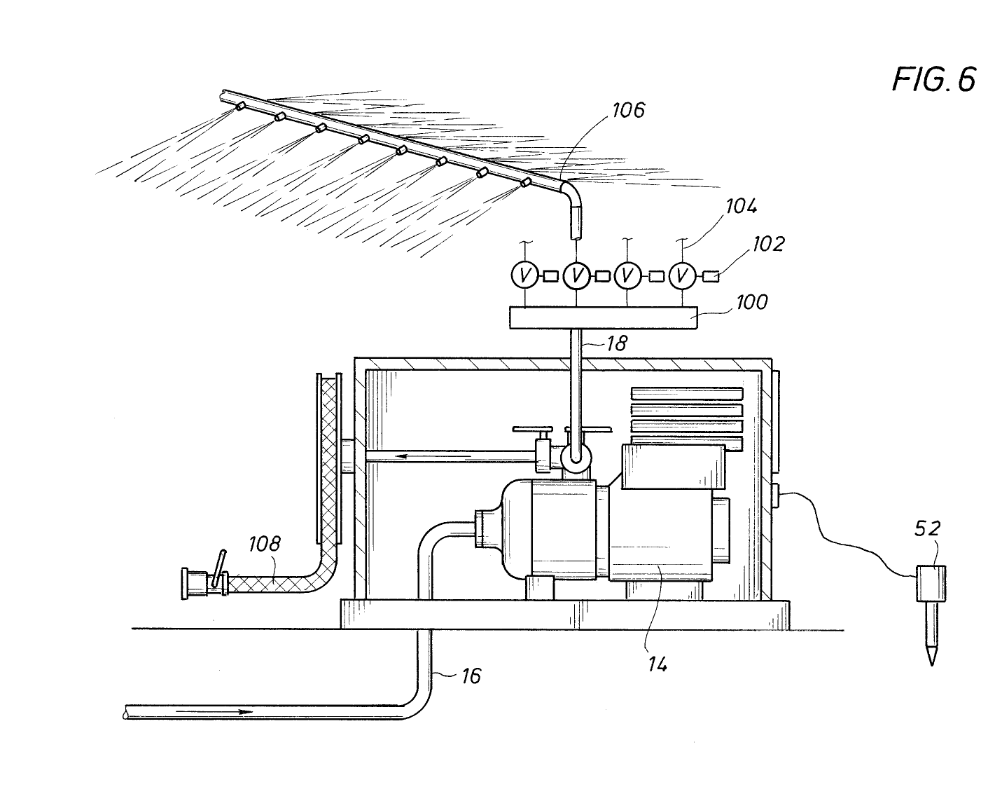

Finally, FIG. 6 illustrates another feature of a fire protection system in which zones of spray are provided. The suction line 16 enters the pump 14, which pumps water out through its discharge line 18. The water enters a manifold 100 which includes a plurality of control valves 102. Each control valve opens under control to pressurize a supply line 104, which provides spray to a portion of the entire system, i.e. a zone of the system. The supply line couples to a spray line 106, which provides a curtain of spray or a portion of the exterior of the dwelling. Thus, each spray line is mounted apart from every other spray line so that it sprays a different zone. Preferably, each control valve is controlled from control panel 28, which receives signals from all of the sensors 52. If a sensor 52 exceeds its control setpoint, such as for example 140° F., then its associated control valve 102 will be directed to open, providing a screen of spray to the zone of the system served by that valve. This feature conserves water from the pool by spraying water to only those portions of the dwelling that are currently threatened with an exterior fire. The system may also be provided with a conventional hose reel 108 for use against exterior fires that are not sensed by the sensors 52.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A fire protection system for a residence having a swimming pool with a drain, the fire protection system comprising:
a pump having a suction and a discharge;
a suction inlet line extending into the swimming pool and coupled to the suction of the pump;
a discharge line coupled to the discharge of the pump;
a first spray line in fluid communication with the discharge line;
a plurality of spray nozzles mounted to the spray line for discharge water spray from the spray line;
a first sensor at a first position exterior to the residence for detecting the approach of a fire to the residence and for developing a control signal at a predetermined criteria upon the approach of a fire to the residence; and
a control system adapted to receive the control signal from the sensor and to automatically start the pump upon receiving the control signal.

2. The system of claim 1, wherein the suction inlet line is in fluid communication with the swimming pool drain.

3. The system of claim 1, further comprising a second sensor at a second position exterior to the residence for detecting the approach of a fire to the residence.

4. The system of claim 1, wherein the first spray line is mounted along a ridge line of the residence.

5. The system of claim 1, wherein the first spray line is mounted along a foundation level of the residence.

6. The system of claim 5, wherein the plurality of spray nozzles spray water in a vertical direction.

7. The system of claim 1, further comprising a second spray line mounted apart from the first spray line.

8. The system of claim 1, further comprising a capture system adapted to receive water sprayed by the system and return the received water to the swimming pool.

9. The system of claim 7, wherein the capture system includes a trench extending at least part way around the residence.

10. The system of claim 7, wherein the capture system includes a trench extending substantially all the way around the residence.

11. The system of claim 7, wherein the capture system includes a trench extending below a concrete footing around at least part way around the residence, the concrete footing having a top surface, the system further comprising a grating extending over the trench and flush with the top surface of the concrete footing.

12. The system of claim 10, further comprising a capture drain line from the trench to the swimming pool.

13. The system of claim 1, further comprising a high level sensor adapted to admit water into the pool when the water level in the pool reaches a first predetermined level and further comprising a low level sensor adapted to stop the pump when the water level in the pool reaches a second predetermined level.

14. A residential exterior deluge system comprising:
a pump having a suction and a discharge;
a water source;
a suction inlet line extending to the water source and coupled to the suction of the pump;
a discharge line coupled to the discharge of the pump;
a first spray line in fluid communication with the discharge line;
a plurality of spray nozzles mounted to the spray line for discharge water spray from the spray line;
a first sensor at a first position exterior to the residence for detecting the approach of a fire to the residence and for developing a control signal at a predetermined criteria upon the approach of a fire to the residence; and
a control system adapted to receive the control signal from the sensor and to automatically start the pump upon receiving the control signal.

15. The system of claim 14, wherein the first spray line is mounted along a first ridge line of the residence.

16. The system of claim 14, further comprising an antenna on the control system adapted to receive a radio frequency signal to start the pump.

17. The system of claim 15, further comprising a second spray line mounted along a second ridge line of the residence, and wherein the first and second spray lines are independently actuatable.
